(19) United States
(12) Patent Application Publication
(10) Pub. No.: US 2006/0024150 A1
(43) Pub. Date: Feb. 2, 2006

(54) Container transportation assist vehicle

(76) Inventor: Lawrence Gregory, West Covina, CA (US)

Correspondence Address: CHAN LAW GROUP LC, 1055 W. 7TH ST,, SUITE 1880, LOS ANGELES, CA, 90017, US

(21) Appl. No.: 11/191,551

(22) Filed: Jul. 28, 2005

Related U.S. Application Data
(60) Provisional application No. 60/592,985, filed on Jul. 29, 2004.

(51) Int. Cl. B60P 1/02

(52) U.S. Cl. 414/495

(57) ABSTRACT

A container transportation assist vehicle (CTAV) according to the present invention may include an assist vehicle having an electric control to enable a user to engage the pilot vehicle to a refuse bin or other suitable container and use the motor or motors of the pilot vehicle to propel and steer the refuse bin or other container to a selected area. Alternatively, the CTAV may be steered manually using a handle coupled with a pivotable wheel. The CTAV further comprises a lifting platform to transfer refuse bin weight to the CTAV for traction, and an attachment means to fixedly engage the refuse bin.

### CROSS REFERENCE TO RELATED APPLICATIONS

The application claims priority to Provisional Application 60/592,985 filed Jul. 29, 2004.

### BACKGROUND OF THE INVENTION

1. Field of the Invention

This invention relates to refuse management systems, and more specifically to remotely controlled, refuse container pilot vehicles.

2. Description of the Prior Art

Refuse management and disposal often requires that refuse bins ranging in size from 1½, 2, 3, and 4 cubic yards be moved, sometimes up hills, for collection. Refuse bins are often stored at locations convenient for the users, and sometimes at locations that are secluded from public view. Many times, such locations are not readily accessible by vehicles used to collect refuse from the bins, and the refuse bins must be moved so that they are accessible to refuse collection vehicles. Conventional practice is to manually move the loaded bins to an area for collection, and the weight of a loaded refuse bin may be beyond the capability of a single operator to move. In some cases an ancillary vehicle such as a pickup truck equipped with apparatus to enable loaded refuse bins to be moved is required to move refuse bins to an area for collection. However, an ancillary vehicle requires an additional operator, and such an ancillary vehicle may not be available in a timely manner when a refuse bin must be moved for access. Therefore, what is needed is a small, electric pilot vehicle, operable by a single individual, to move loaded refuse bins.

### SUMMARY OF THE INVENTION

The present invention provides a container transportation assist vehicle (CTAV) having a remote control thereby enabling a user to couple the assist vehicle with a refuse bin or other suitable container and use the pilot vehicle propulsion system to propel and steer the refuse bin or other container to a selected area.

A refuse bin is a standardized metal container generally in shape of an open rectangular prism and typically having four steel casters, or alternatively two fixed wheels and two casters. The casters or wheels allow a clearance of 8½ inches between the bottom of the refuse bin and the surface upon which it rests. In addition, the refuse bin may have two integral channels, one on each side, to engage with the lifting mechanism of the refuse collection vehicle. An operator positions a CTAV underneath the bin in the space between the bottom of the bin and the surface upon which the bin rests (the space defined by the caster or wheel height). A mechanism on the CTAV raises a lifting platform to engage the bottom of the refuse bin thereby transferring a portion of the bin's weight to the CTAV. Once a portion of the bin's weight is transferred to the CTAV, the CTAV further engages the refuse bin using mechanical, electromagnetic, or suction means. Having thusly engaged the refuse bin, the operator may then activate the pilot's propulsion system to move the refuse bin to another location.

The CTAV propulsion system may comprise at least one electric motor coupled to drive mechanisms, such as wheels or continuous tracks, positioned on each side of the CTAV. Each drive mechanism may be coupled to an independent motor allowing each drive mechanism to be operated independently from the other thereby allowing differential movement of the drive mechanisms. Such differential movement will cause a change in the direction of travel of the CTAV. Alternatively, a handle connected to a pivotable wheel may provide steering.

The drive mechanisms may be articulated or suspended thereby allowing the CTAV to traverse obstacles such as changes in surface elevation, curbs, potholes and the like.

The CTAV may be secured to the refuse bin using one or more electromagnets. One or more electromagnets may be integral with the lifting platform, and when energized, couple the front of the refuse bin to the lifting platform. When the one or more electromagnets are energized, the CTAV is attached to the refuse bin on at least one surface of the bin.

Alternatively, the CTAV may attach to the refuse bin on one or more surfaces using suction devices, mechanical connections, mechanical interferences or any other means. Any means of attaching the CTAV to the refuse bin must have sufficient strength to attach securely and to allow the CTAV to transport a fully loaded bin. In addition to the attachment devices, the CTAV may include one or more stabilizer arms to enhance the stability and control of the CTAV over the refuse bin.

The present invention also includes a remote controller having controls for the one or more drive mechanism as well as controls to enable/disable the engagement device, and to extend and retract the lifting platform. The remote controller may also include one or more displays for such information as battery status, and engagement device status.

The CTAV includes at least one rechargeable electric battery for providing power to the CTAV propulsion system, magnetic attachment devices, lifting platform actuation mechanism, and the controls. A recharging system may be internal or external to the CTAV. An internal recharging system will receive electrical energy in a convenient form from an external source such as 120 volts ac or 12 volts dc, convert the external voltage to the internal battery voltages, and control the charging currents. The at least one rechargeable electric battery may be of any type and capacity suitable for the expected CTAV use. An external recharging system would accept electrical energy in a convenient form and provide at least one nominal dc voltage to the at least one rechargeable battery typically through at one or more plug connections.

The present invention also may include a self lifting carrying rack for a CTAV. The carrying rack may be fitted on a refuse collection truck or other suitable vehicle. A carrying rack may be further fitted with one or more power connectors which may mate with one or more external connections to the CTAV thereby enabling the at least one rechargeable battery to be recharged by the carrying vehicle.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a side view of a CTAV engaging a refuse bin according to the present disclosure.

FIG. 2 is a block diagram of one embodiment of the CTAV of FIG. 1.

FIG. 3 is a block diagram of another embodiment a CTAV according to the present invention.

### DETAILED DESCRIPTION OF THE PREFERRED EMBODIMENT(S)

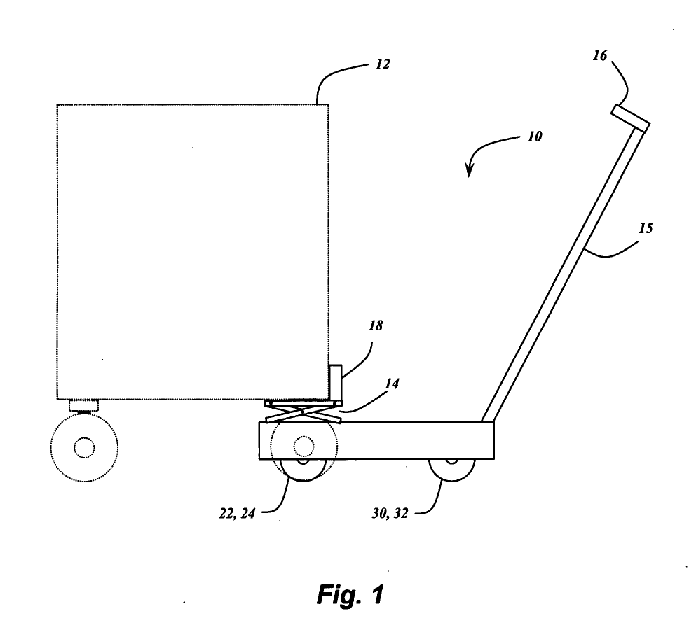

Referring now to FIG. 1, CTAV 10 may engage bin 12 and may be used to move and control bin 12. Lifting platform 14 may be used to engage CTAV 10 to bin 12. The lifting platform 14 is raised until it engages the bottom of the refuse bin 12, and exerts an upward force until a portion of the weight of the refuse bin is transferred to the CTAV 10. The weight transfer ensures that the CTAV 10 has sufficient traction to move the refuse bin 12. Lifting platform 14 may be raised and lowered using any suitable technique. Once the lifting platform 14 has been raised and a portion of the refuse bin 12 weight has been transferred, an attachment mechanism 18 is engaged to secure the refuse bin 12 to the CTAV 10. A portion of the refuse bin 12 weight has now been transferred to the drive wheels 22 and 24 and pivotable wheels or castors 30 and 32. Remote control 16 may be used to control lifting platform 14 as well as the motion and direction of CTAV 10.

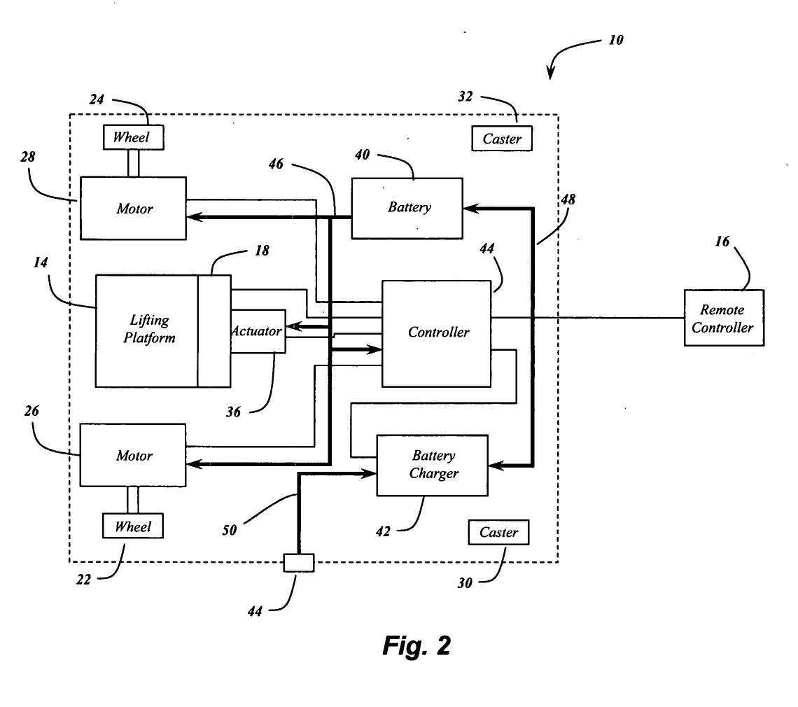

Referring now to FIG. 2, one embodiment of a CTAV 10 is shown. A CTAV 10 may include drive wheels 22 and 24 coupled to drive motors 26 and 28 respectively. The drive wheels 22 and 24 may be coupled to the motors 26 and 28 using any suitable means such as direct drive, gear drive, drive chains or belts, or any other means available to a skilled artisan in the field. Additional pivotable wheels or casters 30 and 32 may be provided for stability and also for allowing differential rotation of drive wheels 22 and 24 to steer the CTAV 10.

Alternative drive systems are contemplated including replacing the drive wheel and caster on each side by a caterpillar type track, and having the differential rotation of each caterpillar track provide steering. Other drive systems within the scope of this invention include multiple drive wheels on each side, or a CTAV 10 having a single drive wheel.

The CTAV 10 of FIG. 2 further comprises a lifting platform 14 that raises and lowers to engage a refuse bin 12, also shown in FIG. 1. The lifting platform 14 may be operated by actuator 36, and the lifting platform mechanism may comprise one or more of any convenient type such as a motor operated scissor jack, electrically or manually operated hydraulic jack, or a screw jack. If electrically operated, the actuator 36 may include feedback to limit the amount of weight transferred from the refuse bin 12 to the CTAV 10.

Attachment mechanism 18 is mounted on the lifting platform 14 for attaching to at least one surface of the refuse bin 12. The attachment mechanism 18 may be an electromagnet, suction or vacuum device, a mechanical connection, or any other attachment mechanism known to a skilled practitioner of the art. The attachment mechanism 18 must have sufficient strength to allow the CTAV 10 to transport a fully loaded refuse bin 12 up a contemplated grade.

Electric motors 26 and 28 receive power from at least one rechargeable battery 40 to propel the drive wheels 22 and 24. The battery 40 is a suitable size and type for the CTAV 10 to operate for a specified duty cycle. A skilled practitioner of the art may determine the battery type, battery voltage, and battery size to optimize cost, weight, and performance.

The CTAV 10 further comprises a battery charger 42 to provide recharging current to the at least one battery 40. Connector 44 is provided to receive external power in a convenient form to supply the battery charger 42. Depending upon a particular application, the external power may be 110/240 vac from an external source or may be 12 vdc from a support vehicle (not shown). It is further contemplated, in another embodiment, that the battery charger 42 may be external to the CTAV 10, in which case the output of the battery charger will be supplied directly to the at least one battery 40. The battery charger 42 may provide the appropriate charging current regulation for the type of battery being charged.

A user controls the operation of the CTAV 10 with a remote controller 16 located at the end of a control handle 15 (see FIG. 1) to provide speed and direction controls for each drive motor 26 and 28, to deactivate each drive motor 26 and 28, to set a safety brake (not shown), to actuate the lifting platform 18, and to actuate the attachment device 38. The remote control 44 also may have status indicators showing remaining battery life and operational status. Further, the remote controller 16 may have a safety switch, which when released, will deactivate the drive motors 26 and 28 and set a safety brake.

In one embodiment of the present invention, control handle 15 is contiguous and inflexible to provide tactile feedback to a user holding remote controller 16. In other embodiments of the present invention, remote controller 16 may connect to CTAV 10 using any suitable technique including but not limited to flexible cable, wireless RF and infrared.

Referring again to FIG. 2, at least one battery provides electrical power to the elements of CTAV 10 through power bus 46. Connector 44 may provide source power to the battery charger 42 via the battery charger bus 50, which provides charging current to the at least one battery 40 over the charging bus 48. Alternatively, if the battery charger 42 is external to the CTAV 10, connector 44 is connected to the at least one battery 40 using the charging bus 48.

Control signals may be produced by controller 44 in response to the remote controller 16 and distributed to the CTAV components. Alternatively, control signals may originate in remote controller 16 and are transmitted directly to the appropriate element of CTAV 10.

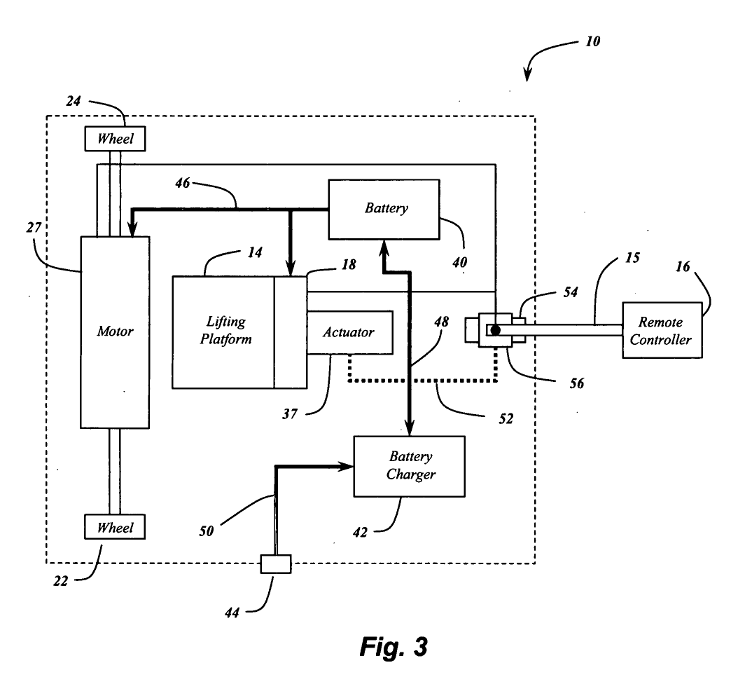

Referring now to FIG. 3, another embodiment of CTAV 10 is shown. Drive wheels 22 and 24 are coupled with a drive motor 27 using any suitable means such as direct drives, gear drives, chains, or belts. The drive wheels 22 and 24 are coupled to the drive motor 27 in such a manner that both drive wheels 22 and 24 rotate in the same direction and at the same speed.

A steerable wheel 54 is provided to control the direction of the CTAV 10 travel. The steerable wheel 54 is coupled to the control handle 15 which is moveable in a left or right direction, thereby steering the CTAV 10.

A lifting platform 14 is also provided to transfer a portion of the refuse bin 12 (see FIG. 1) weight to the CTAV 10. The lifting platform 14 further comprises one or more lifting mechanisms operated by an actuator 37 of a convenient type such as an hydraulic or scissors jack. As shown in FIG. 3, actuator 37 is hydraulically operated by the control handle 15, which is coupled with the hydraulic pump 56. The control handle 15 articulated in such a way to operate hydraulic pump 56 to increase and decrease the hydraulic pressure in the hydraulic line 52 and in the actuator 37. The foregoing is intended to describe only one method to operate the lifting platform 14 and does not limit the use of other methods for operating the lifting platform 14.

Attachment mechanism 18 is mounted on the lifting platform 14 for attaching to at least one surface of the refuse bin 12. The attachment mechanism 18 may be an electromagnet, a suction or vacuum device, a mechanical connection, or any other attachment mechanism known to a skilled practitioner of the art. The attachment mechanism 18 must have sufficient strength to allow the CTAV 10 to transport a fully loaded refuse bin 12 up a contemplated grade.

Electric motor 27 receives power from at least one rechargeable battery 40 to propel the drive wheels 22 and 24. The battery 40 is a suitable size and type for the CTAV 10 to operate for a specified duty cycle. A skilled practitioner of the art may determine the battery type, battery voltage, and battery size to optimize cost, weight, and performance.

The CTAV 10 further comprises a battery charger 42 to provide recharging current to the at least one battery 40. Connector 44 is provided to receive external power in a convenient form to supply the battery charger 42. Depending upon a particular application, the external power may be 110/240 vac from an external source or may be 12 vdc from a support vehicle (not shown). It is further contemplated, in yet another embodiment, that the battery charger 42 may be external to the CTAV 10, in which case the output of the battery charger will be supplied directly to the at least one battery 40. The battery charger 42 may provide the appropriate charging current regulation for the type of battery being charged.

A user controls the operation of this embodiment of the CTAV 10 with a remote controller 16 located at the end of a control handle 15 to provide speed and direction controls for the drive motor 27, to deactivate the drive motor 27, to set a safety brake (not shown), and to actuate the attachment device 18. The remote controller 44 also may have status indicators showing remaining battery life and operational status. Further, the remote controller 16 may have a safety switch, which when released, will deactivate the drive motor 27 and set a safety brake. Manipulating the control handle 15 steers the CTAV 10 and operates the lifting platform 14.

The at least one battery 40 provides electrical power to the elements of CTAV 10 through power bus 46. Connector 44 may provide source power to the battery charger 42 via the battery charger bus 50, which provides charging current to the at least one battery 40 over the charging bus 48. Alternatively, if the battery charger 42 is external to the CTAV 10, connector 44 is connected directly to the charging bus 48 for providing charging current to the at least one battery 40.

Having now described the invention in accordance with the requirements of the patent statutes, practitioners skilled in this art will understand how to make changes and modifications in the present invention to meet their specific requirements or conditions. Such changes and modifications may be made without departing from the scope and spirit of the invention as set forth in the following claims.

What is claimed is:

1. A container transportation assist vehicle (CTAV) for moving a refuse bin comprising:
a first electric motor coupled with a first drive wheel and a second electric motor coupled with a second drive wheel;
a lifting platform for transferring a portion of the weight of the refuse bin to the first and the second drive wheel wherein the lifting platform further comprises an actuator;
an attachment means for securing the CTAV to the refuse bin;
at least one battery for supplying electrical power to the first and the second drive motors;
a battery charger for recharging the at least one battery; and
a control means for controlling the speed and direction of the first and the second electric motors wherein the second electric motor is controlled independently from the first electric motor.

2. The CTAV of claim 1, wherein the lifting platform actuator is electric.

3. The CTAV of claim 1, wherein the lifting platform actuator is hydraulic.

4. The CTAV of claim 1, wherein the lifting platform is mechanical.

5. The CTAV of claim 1, wherein the attachment means is an electromagnet.

6. The CTAV of claim 1, wherein the attachment means is mechanical.

7. The CTAV of claim 1, wherein the attachment means is a suction device.

8. The CTAV of claim 1, wherein the battery charger is integral to the CTAV.

9. The CTAV of claim 1, wherein the battery charger is external to the CTAV.

10. The CTAV of claim 1, wherein the control means further comprises a remote controller and a local controller integral with the CTAV.

11. The CTAV of claim 10, wherein the remote controller is coupled with the controller using an infrared link.

12. The CTAV of claim 10, wherein the remote controller is coupled with the controller using radio waves.

13. A container transportation assist vehicle (CTAV) for moving a refuse bin comprising:
an electric drive motor coupled with a first drive wheel and a second drive wheel;
a lifting platform for transferring a portion of the weight of the refuse bin to the first and the second drive wheel wherein the lifting platform further comprises an actuator;
an attachment means for securing the CTAV to the refuse bin;
at least one battery for supplying electrical power to the electric drive motor;
a battery charger for recharging the at least one battery; and
a control means for controlling the speed and direction of the electric drive motor; and

14. The CTAV of claim 13, wherein the lifting platform actuator is hydraulic.

15. The CTAV of claim 13, wherein the lifting platform actuator is mechanical.

16. The CTAV of claim 13, wherein the attachment means is an electromagnet.

17. The CTAV of system claim 13, wherein the attachment means is mechanical.

18. The CTAV of system claim 13, wherein the battery charger is integral with the CTAV.

19. The CTAV of claim system 13, wherein the battery charger is external to the CTAV.

20. The CTAV of claim system 13, wherein the control means comprises an electric controller and a handle.

21. The CTAV of claim system 20, wherein the handle is coupled with a pivotable wheel to provide steering.

22. The CTAV of claim system 20, wherein the handle is coupled with an hydraulic pump to raise and lower the lifting platform.

23. The CTAV of claim system 20, wherein the electric controller applies a braking means to the first and the second drive wheels when the CTAV is not under control of an operator.

24. The CTAV of claim system 20, wherein the electric controller provides status displays to an operator.

25. A container transportation assist vehicle (CTAV) for moving a refuse bin comprising:
a means for moving a refuse bin from a first location to a second location,
a means for transferring a portion of the weight of a refuse bin to the CTAV;
a means for fixedly coupling the CTAV to the refuse bin;
a means for providing energy to the moving means; and
a means for controlling the speed and direction of the CTAV coupled with the refuse bin.

26. The CTAV of claim 25, wherein the moving means comprises a first electric drive motor and a second electric drive motor.

27. The CTAV of claim 26, wherein the second electric drive motor is operable independently from the first electric drive motor.

28. The CTAV of claim 27, wherein the first electric drive motor is coupled with a first drive wheel and the second electric drive motor is coupled with a second drive wheel.

29. The CTAV of claim 27, wherein the first electric drive motor is coupled with a first continuous tread and the second electric drive motor is coupled with a second continuous tread.

30. The CTAV of claim 25, wherein the moving means further comprises a suspension system for allowing the CTAV to traverse obstacles.

31. The CTAV of claim 25, wherein the moving means comprises an electric drive motor coupled to a first drive wheel and a second drive wheel.

32. The CTAV of claim 25, wherein the transferring means transfers a portion of the refuse bin weight to the CTAV thereby enabling the CTAV to have sufficient traction to move the refuse bin from the first location to the second location.

33. The CTAV of claim 32, wherein the transferring means comprises an actuator.

34. The CTAV of claim 33, wherein the actuator is electric.

35. The CTAV of claim 33, wherein the actuator is hydraulic.

36. The CTAV of claim 33, wherein the actuator is mechanical.

37. The CTAV of claim 25, wherein the coupling means is an electromagnet.

38. The CTAV of claim 25, wherein the coupling means is mechanical.

39. The CTAV of claim 25, wherein the coupling means is a suction means.

40. The CTAV of claim 25, wherein the means for providing energy further comprises at least one storage battery and a battery charger.

41. The CTAV of claim 40, wherein the battery charger is integral with the CTAV.

42. The CTAV of claim 40, wherein the battery charger is external to the CTAV.

43. The CTAV of claim 25, wherein the control means comprises a local controller and a remote controller.

44. The CTAV of claim 43, wherein the control means applies a braking means when the CTAV is not under the control of an operator.

45. The CTAV of claim 43, wherein the control means provides status displays to an operator.

46. The CTAV of claim 43, wherein the remote controller is coupled with the local controller using an infrared link.

47. The CTAV of claim 43, wherein the remote controller is coupled with the local controller using radio waves.

48. The CTAV of claim 25, wherein the control means comprises an electric controller and a handle. The CTAV of claim system 20, wherein the handle is coupled with a pivotable wheel to provide steering.

49. The CTAV of claim system 48, wherein the handle is coupled with an hydraulic pump to raise and lower the lifting platform.

50. The CTAV of claim system 48, wherein the electric controller applies a braking means to the first and the second drive wheels when the CTAV is not under control of an operator.

51. The CTAV of claim system 48, wherein the electric controller provides status displays to an operator.
